(19) United States
(12) Patent Application Publication
(10) Pub. No.: US 2014/0316953 A1
(43) Pub. Date: Oct. 23, 2014

(54) DETERMINING DATACENTER COSTS

(71) Applicant: VMWARE, INC., Palo Alto, CA (US)

(72) Inventors: Mangesh PANGARKAR, Bangalore (IN); Diwakar PRABHAKARAN, Bangalore (IN); Jusvinder SINGH, Jammu (IN)

(73) Assignee: VMware, Inc., Palo Alto, CA (US)

(21) Appl. No.: 13/865,026

(22) Filed: Apr. 17, 2013

(51) Int. Cl. G06Q 30/02; G06Q 40/00

(52) U.S. Cl. CPC G06Q 30/0283; G06Q 40/10
USPC 705/30

(57) ABSTRACT

A method for determining costs associated with at least one datacenter is described. A portal is accessed, the portal operable to provide a data collector. A data collector is received at the at least one data center. Data collected by the data collector sends the data to the portal. A report associated with the costs associated with the at least one datacenter is received.

### BACKGROUND

In any datacenter, understanding the cost dynamics of resources is vital to run the datacenter efficiently. Chargeback is the practice in modern day datacenters to achieve higher cost visibility. With chargeback, users are provided with a tabulation of resource costs allowing them to manage costs effectively. With increased cost factors involved in multi-site, federated datacenters, the cost visibility of datacenters across a multi-site environment is becoming increasingly important.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is an example block diagram illustrating an architecture of Chargeback-as-a-Service, in accordance with various embodiments.

FIG. 2 is an example block diagram illustrating chargeback component interaction, in accordance with various embodiments.

FIG. 3 is a flow diagram of a method of determining costs associated with at least one datacenter, in accordance with various embodiments.

FIG. 4 is a flow diagram of a method of determining costs associated with at least one datacenter, in accordance with various embodiments.

FIG. 5 is a block diagram of an example computer system used in accordance with various embodiments.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “accessing,” “receiving,” “sending,” “subscribing,” “customizing,” “creating,” “presenting,” “providing,” “aggregating,” or the like, often refer to the actions and processes of an electronic computing device or system, such as one or more physical and/or virtual machines, of a target computing environment. The electronic computing device/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Discussion

Herein various systems, methods and techniques for determining costs associated with at least one datacenter are described. Understanding the cost dynamics of resources is vital to running a datacenter efficiently. Some chargeback managers (CBMs) are installed on premise. There, users may configure the installed CBM to produce cost reports based on their needs. Continuously monitoring and maintaining a CBM can be costly. Herein various examples of chargeback-as-a-service are presented. It should be appreciated that a “user” includes, but is not limited to: a datacenter administrator, a service provider, small and medium business (SMB) users, etc.

Discussion begins with an overview of a chargeback-as-a-service system. The chargeback service at the core of this system is then described. Next, data collectors are described. Discussion continues with example portals and example user experiences. An example pricing model is then briefly discussed. Discussion continues with example methods of use. Lastly, an example computer system is discussed.

### Overview of Chargeback-as-a-Service

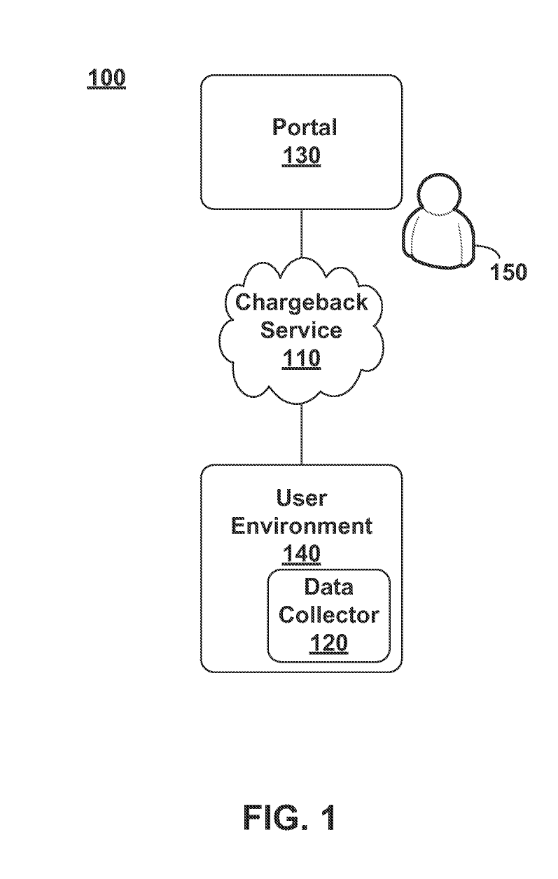

FIG. 1 is an example block diagram illustrating an architecture of chargeback-as-a-service system 100. The example architecture of chargeback-as-a-service system 100 comprises a chargeback service 110, a chargeback manager data collector 120 (herein referred to as a data collector 120), and a chargeback self-servicing portal 130 (herein referred to as a portal 130). Architecture of chargeback-as-a-service system 100 further comprises computing environment 140, which may be a datacenter in various embodiments. These components will be discussed below in greater detail.

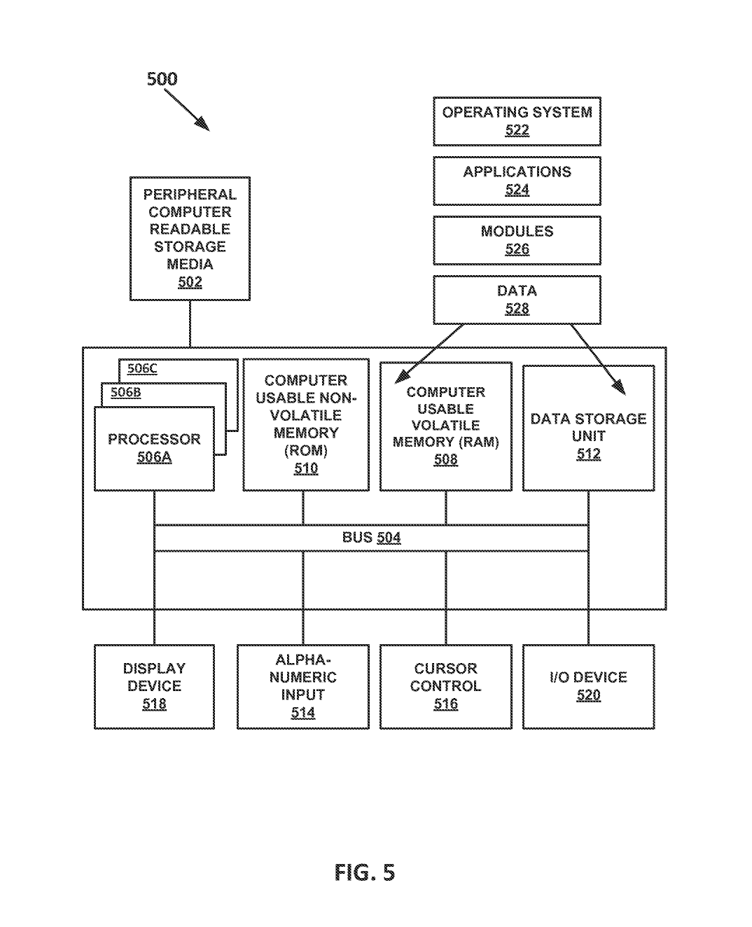

In an embodiment, a chargeback service 110 is a self-service based model that allows users 150 to subscribe to the chargeback service 110 running in a public cloud. For example, a user 150 may subscribe to a chargeback-as-a-service system for a year. After subscribing, in some embodiments, a data collector 120 component is downloaded to a computing environment 140. A computing environment 140 may include, but is not limited to: a datacenter, a federated datacenter, a plurality of computers, a cloud, a private cloud, an internal cloud, an SMB user environment, a computer system 500 (of FIG. 5), etc. After a data collector 120 is downloaded, it begins monitoring the usage of the virtual and physical infrastructure of the computing environment 140. In various embodiments, chargeback-as-a-service system 100 operates as a self-driven, self-installing, self-monitoring tool.

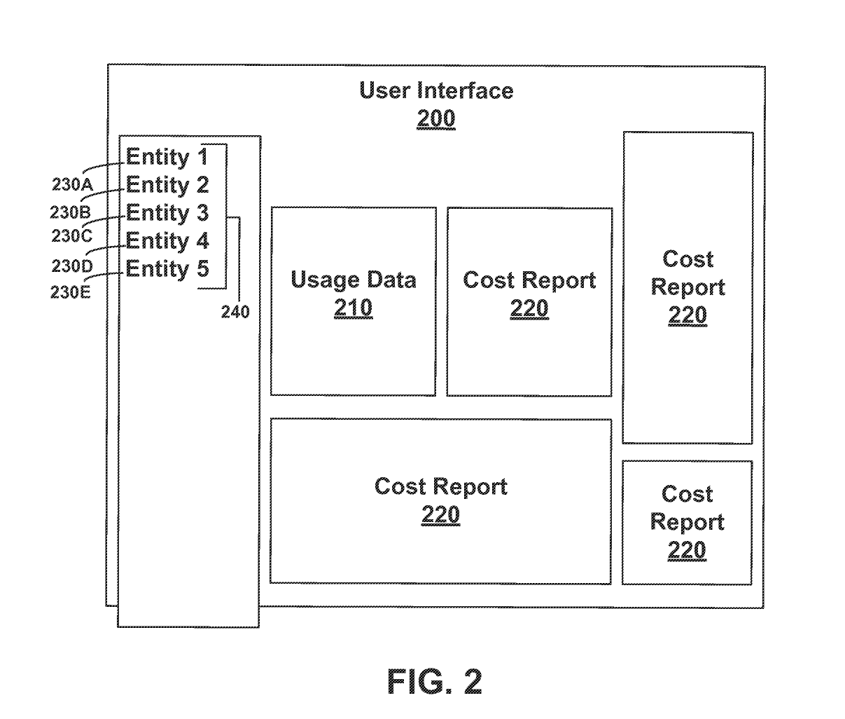

FIG. 2 is an example block diagram illustrating an example user interface 200, in accordance with one embodiment. FIG. 2 shows a user interface 200 that displays resource usage data 210, at least one cost report 220, entities 230 (e.g., 230A, 230B, 230C, 230D, and 230E), and a hierarchy of entities 240. User interface 200 may be presented to a user at a portal 130 (e.g., by a web browser, application on a handheld device, etc.). In some embodiments, chargeback service 110 presents user interface 200. For example, chargeback service 110 may generate user interface 200 and send it to portal 130. In some examples, portal 130 generates user interface 200. Still in other examples, portal 130 and chargeback service 110 combine to generate and/or present user interface 200. In some embodiments, entities 230 include, but are not limited to: virtual machines, virtual computers, computing systems, computing machines, servers, mobile devices, datacenters, computer clusters, electronic devices, electronic components, etc. In an embodiment, a hierarchy of entities 240 is created, which will be discussed in more detail below, in a separate subsection.

In various embodiments, the data collector 120 periodically uploads resource usage data 210 to the chargeback service 110 which runs in a cloud environment. The chargeback service 110 is operable to compute costs associated with the resource usage data 210. In some embodiments, users 150 can login into a portal 130, where the chargeback service 110 computes costs associated with a computing environment 140 and presents them to the user 150 along with various cost analysis data and cost reports 220. Cost reports and cost analysis data may include, but are not limited to: an amount of power consumed per entity 230, how costs vary over time, usage and cost patterns over time, an amount of resources available in each entity 230, an average resources being used by each entity 230, base costs, fixed costs, one-time costs, multiple rate factors, overage fees, rates associated with virtual machines, costs associated with cooling, costs associated with power, costs associated with real estate, costs associated with software licenses, whether particular components are present in the system (e.g., VMware vCloud™, VMware vShield™ Manager, VMware vCenter™ Server, etc.), how virtual machines are grouped, which machines are virtual machines, maintenance costs, deployment costs, aggregate costs across multiple data centers, return on investment analyses, etc.

In some embodiments, cost reports 220 may be customized. For example, a user 150 my configure a cost report 220 to provide the most pertinent information to that user 150, whether the cost report 220 be on a website, in an email, or in a print-out. In some embodiments, templates for cost reports 220 are provided that can be modified and saved by a user 150. In some embodiments, a user 150 may schedule cost reports 220 to be delivered (e.g., via email or at portal 130) at a specified time or time interval. In other embodiments, cost reports 220 are provided in real-time. Thus, chargeback-as-a-service system enables a user 150 to understand and explore the cost dynamics of their infrastructure without having to purchase and maintain in-house software (e.g., a CBM on their computing environment 140).

### Chargeback Service

In some embodiments, an architecture of chargeback-as-a-service system 100 comprises a CBM that is hosted in a public cloud. As discussed briefly above, in some embodiments, a CBM performs end-to-end cost reporting for virtual environments. In some embodiments, these virtual environments may utilize a virtual ization platform for building cloud infrastructures, such as VMware vSphere™. In an embodiment, chargeback service 110 is a web based application that allows users 150 to create custom hierarchies of entities 240 created in the computing environment 140 (e.g., a datacenter, a cloud, VMware vCenter™ Server, VMware vCloud™ Director, etc.). Chargeback service 110 also allows users 150 to configure billing services. Once hierarchies of entities 240 are created, in various embodiments, chargeback service 110 interacts with the computing environment 140 (e.g., a datacenter, a cloud, vCenter Server, VMware vCloud™ Manager, and VMware vShield™ Manager, etc.) to retrieve resource usage data 210 for entities 230, calculate the cost by using defined chargeback formulas, and generate various cost reports 220. As discussed above, cost reports 220 may include resource usage data 210.

While some CBM products are built with the assumption that they will be installed and maintained by a user 150 at a computing environment 140, in some embodiments, chargeback service 110 is able to meet the performance and scalability limits of a wide variety of software-as-a-service applications.

In various embodiments, a user 150 may register at a portal 130 and the portal 130 will provide assistance such that the user 150 may configure options including, but not limited to: the billing information applicable to a computing environment 140, options to save costs associated with a subscription, various types of subscriptions, etc. In some embodiments, a wizard walks a user 150 through how to configure billing information and provides details applicable to the computing environment 140.

In an embodiment, once a data collector 120 begins sending information associated with a computing environment 140, chargeback service 110 may automatically create a corresponding hierarchy of entities 240 for the computing environment 140. In another embodiment, user 150 may create their own hierarchy of entities 240 for the computing environment 140. In some embodiments, a hierarchy of entities 240 may be both automatically created by chargeback service 110 and edited by a user 150. In one embodiment, a hierarchy of entities 240 allows a user 150 to view the costs associated with a plurality of entities 230 rather than viewing the costs associated with each entity 230 individually.

In an embodiment, chargeback service 110 is able to categorize the cost associated with a plurality of computing environments 140. For example, chargeback service 110 can categorize the costs associated with different datacenters belonging to a user 150. Chargeback service 110 is operable to categorize costs associated with a plurality of computing environments 140 based on factors including, but not limited to: geographic location, size of the computing environment 140, company and/or subsidiary that runs/owns computing environment 140, etc. Of course, chargeback service 110 is also capable of computing the overall costs across all computing environments 140. In some embodiments, a chargeback service 110 comprises security that protects the infrastructure inventory, configuration, an usage and/or cost details of a computing environment 140.

### Example Data Collectors

As mentioned above, in various embodiments, data collectors 120 are operable to collect and transmit data from a computing environment 140. A data collector 120 is a simple data collection utility to collect usage and inventory details from a computing environment 140. In various embodiments, one data collector 120 may be used in each computing environment 140. In some embodiments, multiple data collectors 120 are used in a single computing environment 140. In some embodiments, data collectors 120 can extract usage and inventory data from VMware vCenter™ Server, VMware vCloud™ Director, and VMware vShield™ Manager. In some embodiments, a software product may comprise a data collector 120. For example, a user 150 may install a particular product other than a chargeback manager, and this particular product may include and install a data collector 120. Moreover, in some embodiments, a software product unrelated to chargeback-as-a-service system 100 may comprise a free trial subscription to chargeback-as-a-service system 100.

In some embodiments, data collectors 120 can be downloaded and installed in a computing environment 140. In other words, a data collector 120 is pushed into a computing environment 140. Data collectors 120 may be downloaded from a cloud. For example, data collectors 120 may be downloaded from the cloud comprising the chargeback service 110. Data collectors 120 may send usage and/or an inventory data to chargeback service 110. In some embodiments, the data is sent over a secured hyper-text transfer protocol (HTTP).

In various embodiments, data collectors 120 may discover the virtual and/or physical infrastructure of a computing environment 140. Data collectors 120 may be operable to use software products, applications, and technologies to assist in discovering virtual and/or physical infrastructures. In some embodiments, data collectors 120 may give a user 150 an option to define the infrastructure that needs to be monitored. For example, a user 150 may configure a data collector 120 such that it only monitors portions of a computing environment 140. For example, a data collector 120 may be configured to monitor particular machines based on geography or some other feature. As another example, a data collector 120 may be configured to measure certain types of usages including, but not limited to: the amount of power consumed per entity 230, the amount of resources available in each entity 230, the average resources being used by each entity 230, base costs, fixed costs, one-time costs, multiple rate factors, overage fees, rates associated with virtual machines, costs associated with cooling, costs associated with power, costs associated with real estate, costs associated with software licenses, maintenance costs, deployment costs, etc.

In various embodiments, a data collector 120 may perform in different ways. For example, in some embodiments, a data collector 120 streams information to a chargeback service 110 rather than waiting until a certain amount of data is collected. In some embodiments, a data collector 120 filters data it collects such that only a portion of the data collected by the data collector 120 that is sent to the chargeback service 110. For example, only data associated with power usage is sent to chargeback service 110. Or, as another example, only data associated with the infrastructure is sent to chargeback service 110. In some embodiments, data collector 120 may aggregate data from a plurality of machines prior to sending the aggregated data to chargeback service 110. In some embodiments, data collector 120 may aggregate a plurality of types of data prior to sending the aggregated data to chargeback service 110. For example, data collector 120 may aggregate data from all the machines in a certain geographic location prior to sending data to chargeback service 110. As another example, data collector 120 may aggregate all power usage data prior to sending the power usage data back to chargeback service 110. Of course, in some embodiments, data collector 120 sends all data it gathers to chargeback service 110 without regard for the type of data gathered.

### Example Portal

In some embodiments, a portal 130 is the web interface which a user 150 may connect to from a machine. A user 150 may connect to a portal 130 with a web browser. In some embodiments, a user 150 may connect to portal 130 with a machine that is remote from a computing environment 140, or a machine that is a part of a computing environment 140. In one example, a user 150 may connect to a portal with an application (e.g., an application on a hand held device, an application on a machine, etc.), rather than through a web browser. In some embodiments, the portal 130 is self-servicing. In other words, the portal 130 is a self-service portal.

In various embodiments, portal 130 allows a user 150 to register with Chargeback-as-a-Service. Portal 130 may allow a user 150 to register their personal preferences, billing, and/or configuration details. This includes allowing a user 150 to configure and/or personalize any cost reports 220 produced by the chargeback service 110. In an embodiment, data collectors 120 may be downloaded from portal 130. Once a data collector 120 collects a sufficient amount of data, a user 150 may generate cost reports 220 using portal 130. In various embodiments, users 150 may customize portal 130. In other words, users 150 may be able to change the format of portal 130 by placing various widgets (e.g., controls) such that portal 130 displays pertinent information to a user 150. In some embodiments, a user 150 may save their customized portal 130 format (e.g., as a template).

### Example User Experience

As an example, a user 150 may perform the following steps when interacting with chargeback-as-a-service system 100. First, a user 150 may visit a portal 130 that can be accessed at a particular web address. User 150 is a datacenter user and may also be a user of a of virtualization platform, such as VMware vSphere™. If the user 150 is new, then user 150 may create an account. Once the account belonging to the user 150 is created, the user 150 may login. Next, the chargeback service 110 may provide a user 150 with an option to download and install one or more data collectors 120. The user 150 installs at least one data collector 120 at the computing environment 140. During the installation process, the data collector 120 may provide a user 150 with questions. The answers to these questions may assist the data collector 120 in better understanding the computing environment 140. Example questions may include, but are not limited to: asking whether a data collector 120 should monitor operations of certain software products such as virtualization platform products, products that facilitation and/or orchestrate the provisioning of software-defined datacenter services, and the like; asking about the geographical details of the computing environment 140; asking how often the infrastructure inventory and/or resource usage data 210 needs to be uploaded to the chargeback service 110; etc. Once the data collector 120 is installed and running, the data collector 120 uploads the inventory information back to the chargeback service 110. Note that inventory information may include information associated with entities 230. Next, a user 150 may login to the portal 130 and generate various reports, analyze and export the reports in customizable formats, etc. Portal 130 may also display a user interface 200 that comprises a cost report 220 and/or resource usage data 210. User interface 200 may be customizable such that a user 150 can quickly access pertinent information about computing environment 140.

### Example Pricing Model

Users 150 may be charged in various manners for using Chargeback-as-a-Service. For example, users 150 may be charged based on the number of entities 230 monitored by chargeback-as-a-service system 100. In some embodiments, a “pay as you go” model may be used where chargeback-as-a-service system 100 charges only for the entities 230 it collects data from. In another example, chargeback-as-a-service system 100 may charge users 150 based on the allocation or the capacity of their computing environment 140. In another embodiment, chargeback-as-a-service system 100 may be provided as an add-on for another product. For example, chargeback-as-a-service system 100 may be provided as a value add-on for users 150 of certain software products and/or applications.

### Example Methods of Operation

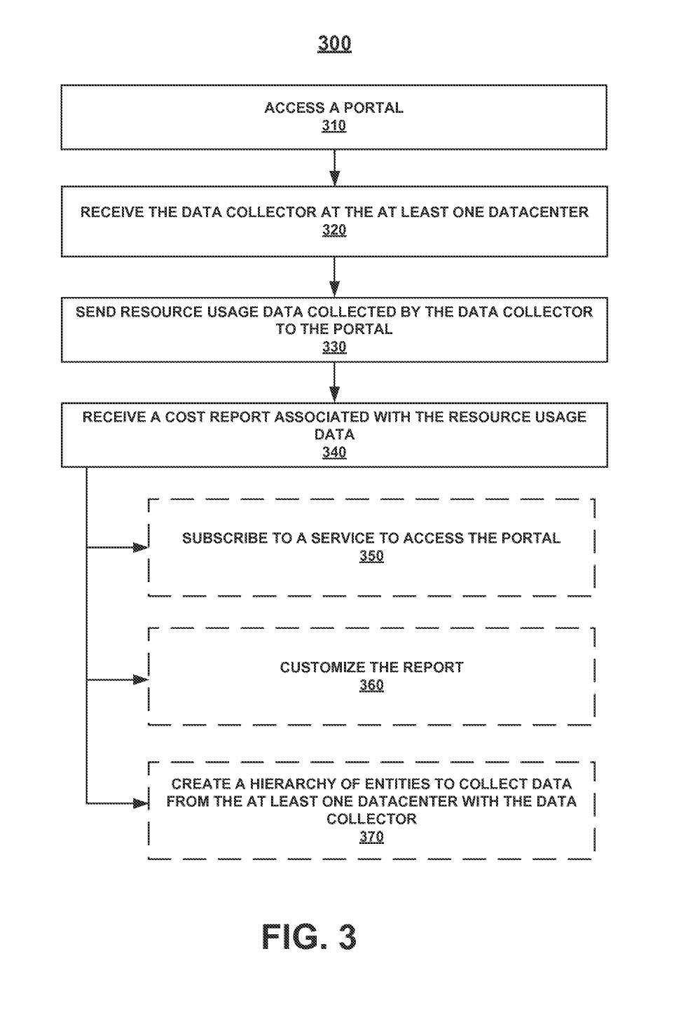

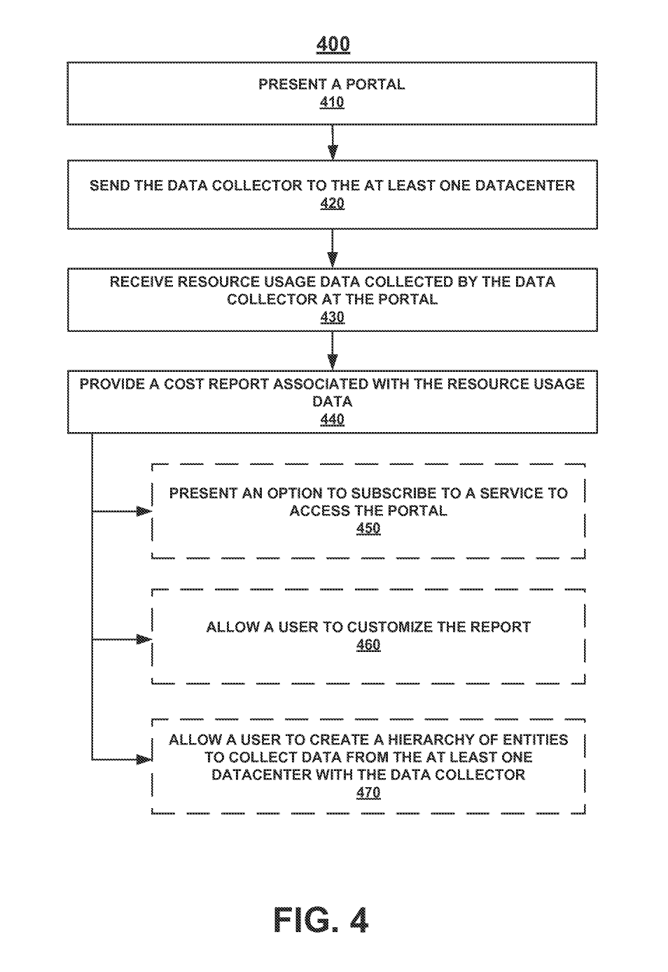

The following discussion sets forth in detail the operation of some example methods of operation of embodiments. With reference to FIGS. 3 and 4, flow diagrams 300 and 400 illustrate example procedures used by various embodiments. Flow diagrams 300 and 400 include some procedures that, in various embodiments, are carried out by a processor under the control of computer-readable and computer-executable instructions. In this fashion, procedures described herein and in conjunction with flow diagrams 300 and/or 400 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments and/or cloud based entities. The computer-readable and computer-executable instructions, which reside on tangible computer readable storage media, are used to control or operate in conjunction with, for example, one or some combination of processors of a system such as the one shown in FIG. 5, or those found in a cloud based environment. It is appreciated that the processor(s) may be physical or virtual or some combination (it should also be appreciated that a virtual processor is implemented on physical hardware).

Although specific procedures are disclosed in flow diagrams 300 and 400, such procedures are examples. That is, embodiments are well suited to performing various other procedures or variations of the procedures recited in flow diagrams 300 and/or 400. Likewise, in some embodiments, the procedures in flow diagrams 300 and/or 400 may be performed in an order different than presented and/or not all of the procedures described in one or more of these flow diagrams may be performed. It is further appreciated that procedures described in flow diagrams 300 and/or 400 may be implemented in hardware, or a combination of hardware with firmware and/or software.

FIG. 3 is a flow diagram 300 of a method of determining costs associated with at least one datacenter, in accordance with various embodiments.

At procedure 310 of flow diagram 300, in some embodiments, a portal 130 is accessed. Portal 130 may be a website a user 150 can access. Portal 130 may be accessed from a device that is remote from the computing environment 140 that the user 150 wishes to monitor, or from a device that is a part of the computing environment 140 that the user 150 wishes to monitor. For example, a user 150 may access portal 130 with a computer that is part of the datacenter that the user 150 is monitoring/will monitor with chargeback-as-a-service system 100. In some embodiments, a user 150 must have a subscription before the user 150 can access the portal 130. In some embodiments, portal 130 connects user 150 to chargeback service 110. In some embodiments, data collector 120 may be downloaded from portal 130.

At procedure 320 of flow diagram 300, in some embodiments, the data collector 120 is received at the at least one datacenter. In various embodiments, a datacenter is a computing environment 140. In some embodiments, data collector 120 is received from either portal 130 or chargeback service 110. In various embodiments, a data collector 120 may send information back to chargeback service 110. As discussed above, the data sent to chargeback service 110 may comprise, but is not limited to: all data collected by the data collector 120, an aggregation of particular types of data, a stream of data, etc.

At procedure 330 of flow diagram 300, in some embodiments, resource usage data 210 collected by the data collector 120 is sent to the portal 130. In various embodiments, resource usage data 210 collected by a data collector 120 is streamed to the portal 130 and/or the chargeback service 110. Resource usage data 210 may include, but is not limited to: an amount of power consumed per entity 230, how costs vary over time, usage and cost patterns over time, an amount of resources available in each entity 230, an average resources being used by each entity 230, base costs, fixed costs, one-time costs, multiple rate factors, overage fees, rates associated with virtual machines, costs associated with cooling, costs associated with power, costs associated with real estate, costs associated with software licenses, whether particular components are present in the system (e.g., VMware vCloud™, VMware vShield™ Manager, VMware vCenter™ Server, etc.), how virtual machines are grouped, which machines are virtual machines, maintenance costs, deployment costs, aggregate costs across multiple data centers, return on investment analyses, etc.

At procedure 340 of flow diagram 300, in some embodiments, a cost report 220 associated with the resource usage data 210 is received. In various embodiments, a cost report 220 is received from a portal 130 and/or chargeback service 110. In some embodiments, chargeback service 110 computes a cost report 220. In various embodiments, a cost report 220 may be shown at portal 130, emailed to a user 150, mailed to a user 150, etc. In any case, in various embodiments, a cost report 220 is customizable such that a user 150 may quickly view information pertinent to that particular user 150. Cost reports 220 may include, but are not limited to: an amount of power consumed per entity 230, how costs vary over time, usage and cost patterns over time, an amount of resources available in each entity 230, average resources being used by each entity 230, base costs, fixed costs, one-time costs, multiple rate factors, overage fees, rates associated with virtual machines, costs associated with cooling, costs associated with power, costs associated with real estate, costs associated with software licenses, whether particular components are present in the system (e.g., VMware vCloud™, VMware vShield™ Manager, VMware vCenter™ Server, etc.), how virtual machines are grouped, which machines are virtual machines, maintenance costs, deployment costs, aggregate costs across multiple data centers, return on investment analyses, etc.

At procedure 350 of flow diagram 300, in some embodiments, a service is subscribed to in order to access the portal 130. In various embodiments, a user 150 subscribes to chargeback-as-a-service system 100 before the user 150 is granted access to portal 130 and/or before a data collector 120 is downloaded. Subscriptions may vary in length and cost. Moreover, in some embodiments, free trial subscriptions are offered. These free trial subscriptions may be based on the type of user 150 purchasing the subscription (e.g., a business of a particular size), or based on the type of software the subscription is bundled with (e.g., if the subscription is bundled with a particular product).

At procedure 360 of flow diagram 300, in some embodiments, a cost report 220 is customized. As discussed above, a cost report 220 may be customized in numerous ways. For example, a cost report 220 may be configured such that particular costs are provided when a user 150 logs into portal 130. As another example, a portal 130 may be customized such that particular portions and/or entire cost reports are presented in various places in a custom user interface 200.

At procedure 370 of flow diagram 300, in some embodiments, a hierarchy of entities 240 is created to collect data from the at least one datacenter with the data collector 120. For example, a user 150 may create and/or modify a hierarchy of entities 240. This may allow a user 150 to view a particular group of entities 230. For example, a cost report 220 may be based at least in part on a hierarchy of entities 240.

FIG. 4 is a flow diagram 400 of a method of determining costs associated with at least one datacenter, in accordance with various embodiments.

At procedure 410 of flow diagram 400, in some embodiments, a portal is presented. Portal 130 may be a website a user 150 can access. In some embodiments, a user 150 must have a subscription before the user 150 can access the portal 130. In some embodiments, portal 130 connects user 150 to chargeback service 110. In some embodiments, data collector 120 may be downloaded from portal 130.

At procedure 420 of flow diagram 400, in some embodiments, a data collector 120 is sent to the at least one datacenter. In various embodiments, a datacenter is a computing environment 140. In some embodiments, data collector 120 is sent from either portal 130 or chargeback service 110. In various embodiments, a data collector 120 may send information back to chargeback service 110 and/or portal 130.

At procedure 430 of flow diagram 400, in some embodiments, resource usage data 210 is received by a data collector 120 at a portal 130. In various embodiments, resource usage data 210 collected by a data collector 120 is streamed and/or uploaded to a portal 130 and/or the chargeback service 110.

At procedure 440 of flow diagram 400, in some embodiments, a cost report 220 associated with the resource usage data 210 is provided. In various embodiments, a cost report 220 is received from a portal 130 and/or chargeback service 110. In some embodiments, metrics within chargeback service 110 compute a cost report 220. In various embodiments, a cost report 220 may be shown at portal 130, emailed to a user 150, mailed to a user 150, etc. In any case, in various embodiments, a cost report 220 is customizable such that a user 150 may quickly view information pertinent to that particular user 150.

At procedure 450 of flow diagram 400, in some embodiments, an option to subscribe to a service to access a portal 130 is presented. In various embodiments, a user 150 subscribes to chargeback-as-a-service system 100 before the user 150 is granted access to portal 130 and/or before a data collector 120 is downloaded. Subscriptions may vary in length and cost. Moreover, in some embodiments, free trial subscriptions are offered. These free trial subscriptions may be based on the type of user 150 purchasing the subscription (e.g., a business of a particular size), or based on the type of software the subscription is bundled with (e.g., if the subscription is bundled with a particular product).

At procedure 460 of flow diagram 400, in some embodiments, a user 150 is allowed to customize the cost report 220. For example, a cost report 220 may be configured such that particular costs are provided when a user 150 logs into portal 130. As another example, a portal 130 may be customized such that particular portions and/or entire cost reports are presented in various places in a custom user interface 200.

At procedure 470 of flow diagram 400, in some embodiments, a user 150 is allowed to create a hierarchy of entities 240 of entities 230 to collect data from the at least one datacenter with the data collector 120. For example, a user 150 may create and/or modify a hierarchy of entities 240. This may allow a user 150 to view a particular group of entities 230. For example, a cost report 220 may be based at least in part on a hierarchy of entities 240.

### Example Computer System

FIG. 5 is a block diagram of a an example computing system used in accordance with various embodiments. With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of computer (computer system 500) that can be used in accordance with or to implement various embodiments which are discussed herein. It is appreciated that computer system 500 of FIG. 5 is an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. Computer system 500 of FIG. 5 is well adapted to having peripheral tangible computer-readable storage media 502 such as, for example, a floppy disk, a compact disc, digital versatile disc, other disc based storage, universal serial bus “thumb” drive, removable memory card, and the like coupled thereto. The tangible computer-readable storage media is non-transitory in nature.

System 500 of FIG. 5 includes an address/data bus 504 for communicating information, and a processor 506A coupled with bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g., random access memory (RAM), coupled with bus 504 for storing information and instructions for processors 506A, 506B, and 506C. System 500 also includes computer usable non-volatile memory 510, e.g., read only memory (ROM), coupled with bus 504 for storing static information and instructions for processors 506A, 506B, and 506C. Also present in system 500 is a data storage unit 512 (e.g., a magnetic or optical disk and disk drive) coupled with bus 504 for storing information and instructions. System 500 may also include an alphanumeric input device 514 including alphanumeric and function keys coupled with bus 504 for communicating information and command selections to processor 506A or processors 506A, 506B, and 506C. System 500 may also include cursor control device 516 coupled with bus 504 for communicating user input information and command selections to processor 506A or processors 506A, 506B, and 506C. In one embodiment, system 500 may also include display device 518 coupled with bus 504 for displaying information.

Referring still to FIG. 5, display device 518 of FIG. 5, when included, may be a liquid crystal device, cathode ray tube, plasma display device or other display device suitable for creating graphic images and alphanumeric characters recognizable to a user. Cursor control device 516, when included, allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

Example embodiments of the subject matter are thus described. Although various embodiments of the have been described in a language specific to structural features and/or methodological acts, it is to be understood that the appended claims are not necessarily limited to the specific features or acts described above. Rather, the specific features and acts described above are disclosed as example forms of implementing the claims and their equivalents.

What is claimed is:

1. A method of determining costs associated with at least one datacenter, said method comprising:
accessing a portal, wherein said portal is operable to provide a data collector, said accessing accomplished by a computer system;
receiving said data collector at said at least one datacenter;
sending resource usage data collected by said data collector to said portal; and
receiving a cost report associated with said resource usage data, wherein said cost report is received from said portal.

2. The method of claim 1, further comprising:
subscribing to a service to access said portal.

3. The method of claim 1, further comprising:
customizing said report.

4. The method of claim 1, further comprising:
creating a hierarchy of entities to collect data from said at least one datacenter with said data collector.

5. The method of claim 1, wherein said sending resource usage data collected by said data collector to said portal comprises:
aggregating said data collected by said data collector prior to sending said data.

6. The method of claim 1, wherein said sending resource usage data collected by said data collector to said portal comprises:
sending resource usage data collected from entities detected by said data collector within said at least one datacenter.

7. The method of claim 1, wherein said receiving a cost report associated with said resource usage data comprises:
receiving said cost report comprising cost analysis data.

8. The method of claim 1, wherein said receiving a cost report associated with said resource usage data comprises:
receiving a cost report comprising an aggregation of said resource usage data associated with costs collected from a plurality of datacenters.

9. A method of determining costs associated with at least one datacenter, said method comprising:
presenting a portal, wherein said portal is operable to provide a data collector;
sending said data collector to said at least one datacenter;
receiving resource usage data collected by said data collector at said portal; and
providing a cost report associated with said resource usage data, wherein said cost report is provided by said portal.

10. The method of claim 9, further comprising:
presenting an option to subscribe to a service to access said portal.

11. The method of claim 9, further comprising:
allowing a user to customize said report.

12. The method of claim 9, further comprising:
allowing a user to create a hierarchy of entities to collect data from said at least one datacenter with said data collector.

13. The method of claim 9, wherein said receiving resource usage data collected by said data collector at said portal comprises:
receiving aggregated data collected by said data collector.

14. The method of claim 9, wherein said receiving resource usage data collected by said data collector at said portal comprises:
receiving said resource usage data from entities detected by said data collector within said at least one datacenter.

15. The method of claim 9, wherein said providing a cost report associated with said resource usage data comprises:
providing said cost report comprising cost analysis data.

16. The method of claim 9, wherein said wherein said providing a cost report associated with said resource usage data comprises:
providing said cost report comprising an aggregation of data associated with costs collected from a plurality of datacenters.

17. A non-transitory computer readable storage medium having instructions embodied therein that when executed cause a computing system to perform a method of determining costs associated with at least one datacenter, said method comprising:
accessing a portal, wherein said portal is operable to provide a data collector, said accessing accomplished by a computer system;
receiving said data collector at said at least one datacenter;
sending resource usage data collected by said data collector to said portal; and
receiving a cost report associated with said resource usage data, wherein said cost report is received from said portal.

18. The non-transitory computer readable storage medium of claim 17, further comprising:
subscribing to a service to access said portal.

19. The non-transitory computer readable storage medium of claim 17, further comprising:
customizing said report.

20. The non-transitory computer readable storage medium of claim 17, wherein said sending resource usage data collected by said data collector to said portal further comprises:
aggregating said data collected by said data collector prior to sending said data.
